(19) United States
(12) Patent Application Publication
(10) Pub. No.: US 2019/0120303 A1
(43) Pub. Date: Apr. 25, 2019

(54) Brake Shoe Hold Down Retainer Cap Release and Reinstallation Tool

(71) Applicant: Arye L. Goodman, Bensalem, PA (US)

(72) Inventor: Arye L. Goodman, Bensalem, PA (US)

(21) Appl. No.: 15/709,564

(22) Filed: Oct. 25, 2017

(51) Int. Cl. F16D 65/00; B25B 27/00

(52) U.S. Cl. CPC F16D 65/0043; F16D 2250/0084; B25B 27/0035

(57) ABSTRACT

A brake shoe hold down retainer cap release and reinstallation tool which includes an internal member notched on its face which enables a quarter turn rotation of the barbed hold down pin which in turn allows for the release of the brake shoe hold down retainer nail. The rotatable internal member features a thumb lever. External longitudinal member features a plurality of protrusions for engaging the hold down retainer cap while preventing sympathetic rotation of said retainer cap while torque is applied to barbed hold down pin. The removal and subsequent reinstallation of the brake shoe retainer hardware is an integral part of the brake shoe replacement process.

### TECHNICAL FIELD

This invention relates to the field of brakes shoes. Specifically, it relates to a tool that facilitates the removal and reinstallation of brake shoe hold down hardware.

### BACKGROUND

In principle, the present invention relates to a tool and a method for removal and subsequent reinstallation of brake shoe retaining hardware; including retainer cap, barbed hold down pin, and hold down pressure spring. The maintenance and replacement of worn brake shoes for vehicles typically requires the disassembly and reassembly of the retaining hold down hardware. Prior art tools accomplished this task by grabbing outer edge of hold down retainer cap and rotating it until the slot in the cap is aligned with barbed head of the hold down pin. Said prior art tools are not always reliable as they frequently do not grab the outer edge of the cap with sufficient force to permit the proper rotation. Additionally said prior art tools are particularly difficult to use when the brake shoe retaining hardware is located internally to brake hub. There is therefore a need for a device and method for reliably disassembling and reassembling the brake shoe retaining hardware.

### SUMMARY OF THE PRESENT INVENTION

One aspect of the present invention is a tool for removal and reinstallation of brake shoe hold down retaining hardware, the tool comprising; an external hollow tube, the tube terminating in a grip end; a rotatable solid rod member positioned longitudinally and internally with respect to the external hollow tube, wherein the internally positioned rod member spaced apart from internal walls of the external hollow tube by means of at least one spacer located inside the tube; a notch on face end of internally positioned rod member, said notch configured to engage a protrusion of a nail of the brake shoe hold down hardware, the rod member also having at a rear end in a finger lever that is substantially perpendicular to a remainder of the rod member, said finger lever traversing the space on the surface of the tube, said finger lever configured to be turned longitudinally and horizontally.

Another aspect of the present invention is a method of effectively disassembling and reassembling brake shoe hold down retainer hardware, said method comprising positioning a tool adjacent brake shoe hold down hardware, the tool comprising a rotatable rod member positioned longitudinally and internally to an external hollow tube member; a notch on face end of internal rod member and a finger lever of a perpendicularly attached to terminating end of rod member; a notched space in the external tube, permitting the longitudinal and horizontal positioning of finger lever, such that a notch on a face end of the internal rod member is above and engaged to a barbed head of hold down pin of the brake shoe hold down hardware; while applying axial pressure on brake shoe hold down retainer cap so as to compress hold down spring, simultaneously rotating a finger lever so as to align brake shoe hold down nail barb with corresponding slot in brake shoe hold down retaining cap, said finger lever protruding perpendicularly from the internal rod member through a space in the external tube.

Embodiments of the disclosed invention can be described as a tool for removal of a brake shoe. The tool has a solid handle fixedly connected/forming a unitary structure with a hollow elongated shaft which is in-line with an elongated most length of the handle in embodiments. The hollow elongated shaft has at least one side cutout through which a finger lever extends, the finger lever having a 90 degree bend such that the lever also passes out of a bottom side (side opposite the solid handle) of the hollow elongated shaft. An indentation in a bottom side of the finger lever can be used to grasp a brake cap and twist the brake cap, removing it from a brake shoe. This is accomplished in embodiments of the disclosed invention, by placing the indentation against the brake cap, compressing a spring of the brake shoe by pressing the handle (and elongated hollow shaft) against same, and rotating the finger lever within the hollow elongated shaft causing the brake cap to rotate.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a schematic side view of a tool, in accordance with one embodiment of the present invention;

FIG. 2 is a schematic side view of a prior art brake shoe hold down hardware to which the tool of FIG. 1 may be applied;

FIG. 3 is a schematic view of the prior art retaining nail of FIG. 2 showing its barb-like protrusion;

FIG. 4 is a schematic end view of a prior art retaining cap forming part of the hardware of FIG. 2;

FIG. 5 is a schematic view of the tool of FIG. 1 engaged with the brake shoe hold down hardware of FIGS. 2-4, in accordance with one embodiment of the present invention; and

FIG. 6A shows a perspective view of the tool being used to remove a retaining cap in an embodiment of the present invention.

FIG. 6B shows a side cutaway view of the tool being used to remove a retaining cap in an embodiment of the present invention.

### DETAILED DESCRIPTION OF THE PRESENT INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a tool for the brake shoe installation process. It allows more effective disassembling and reassembling of brake shoe hold down retainer hardware. A rotatable notched rod member is configured to engage a barb-like protrusion of a retaining nail forming part of the brake shoe hold-down hardware. so that disassembly and reassembly of the retaining hold down hardware can be accomplished efficiently and even in cases where the hardware is internal to the brake hub.

In contrast to prior art tools used for engaging brake shoe hold down hardware, in which the tool attempts to grab the retaining cap and rotate said cap until slot in cap is brought into alignment with barb-like protrusion of hold down nail, the present invention instead grabs and rotates the retaining nail itself bringing said retaining nail into alignment in a more controlled and precise manner. For example, in the present invention, the tool grabs the flat barb-like protrusion 112 of the hold down retaining nail 110 and rotates it until it is aligned with the corresponding slot 132 in the retaining cap 130 thereby allowing removal of brake shoe to proceed. In contrast to prior art tools and methods for assembling and reassembling brake shoe hold down retainer hardware, in which the tool fails to grab the retaining cap on account of imprecise manufacturing of the cap, which results in slight variations in the diameter of the cap, the present invention focuses on rotating the retaining nail, which is a different approach toward disassembly. In addition, in contrast to prior art tools and methods, in which the cap has a tendency to easily deflect in an arbitrary orientation, which deflection allows the cap to slip when the prior art tools are brought to bear, in the present invention, this difficulty does not arise and the tool is able to securely, and in a controlled manner, engage and manipulate the retaining nail and release the brake shoe hold down hardware to release the brake shoe.

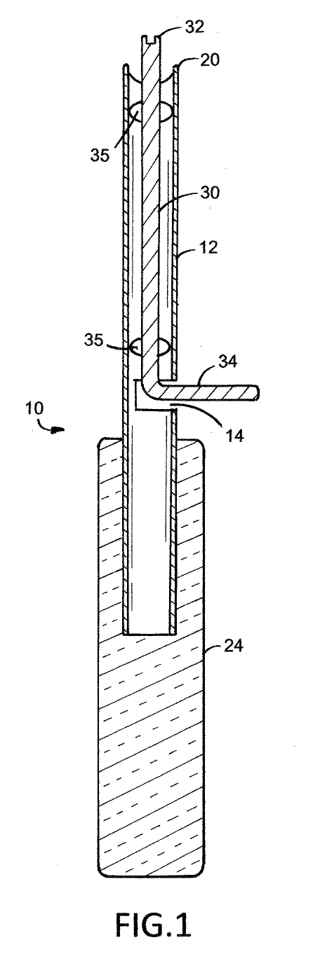

The principles and operation of a Brake Shoe Hold Down Retainer Cap Release and Reinstallation Tool and method according to the present invention may be better understood with reference to the drawings and the accompanying description. Referring to FIG. 1, the tool 10 is comprised of an external hollow tube member 12 and a plurality of protrusions 20 on the face and a grip end 24. Inside the external tube 12 is the internal rotatable rod 30. The internal rotatable rod 30 has a rotatable thumb lever 34 at one end and a notched face 32 at the other end. Internal positioning washers 35 allow axial rotation of internal rotating rod 30 while a maintaining consistent spatial positioning to external hollow tube 12.

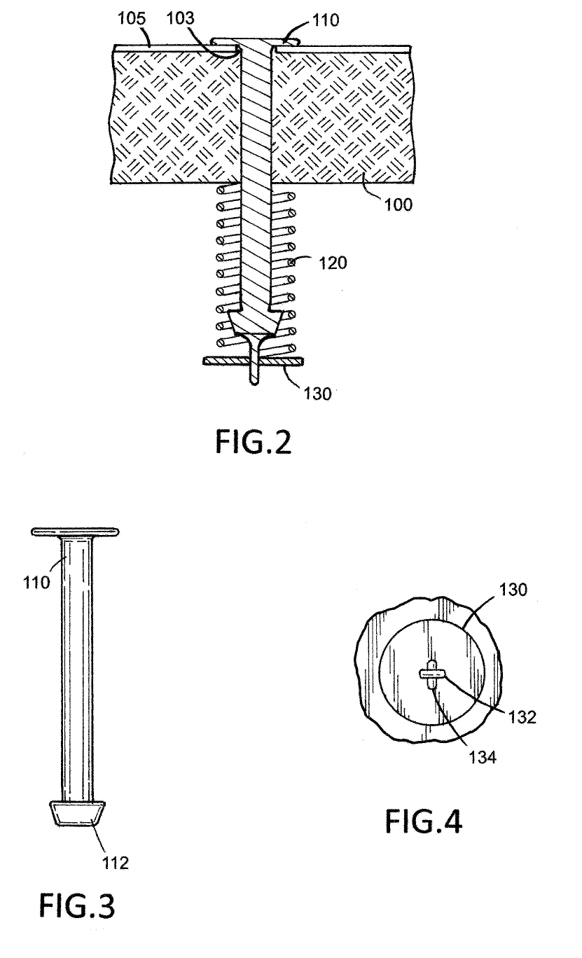

Referring to FIG. 2, there is depicted a typical brake shoe hold down assembly having a fixed backing plate 105 with a retaining nail 110 inserted through an appropriately positioned hole 107, a pressure spring 120 designed to exert tension on brake material being secured 100, a cap 130 which engages the barb like protrusion 112 at the terminus of retaining nail 110. The cap 130 features a slot 132 which allows the barb like protrusion 112 to pass, and a retaining indentation 134 which keeps tension on the pressure spring 120 when the installation is complete.

The invention is employed in the following manner according to one preferred embodiment. An assembler grabs the tool 10 by the grip 24 and aligns the notched face 32 of the internal rotatable rod 30 with the barb like protrusion 112 of the retaining nail 110. The user should align the notched face 32 of the tool so that the notched face 32 is directly in alignment with the retaining nail 110. Pressure should be exerted by tool 10 in a forward direction thereby exerting pressure on cap 130 and compressing pressure spring 120. While this pressure spring 120 is in the compressed position, thumb lever 34 is rotated 90 degrees and nail 110 is rotated so that barb like protrusion 112 is lined up with the slot 132 on the face of cap 130. Then, the user preferably slowly releases forward pressure on tool 1. Doing so allows cap 130 to disengage from the barb like protrusion 112. Retaining cap 130 and pressure spring 120 are now removed from retaining nail 110 and further disassembly of brake shoe hardware can continue.

One embodiment of the present invention is a method 100 of effectively disassembling and reassembling brake shoe hold down retainer hardware. Method 100 includes a step 110 of positioning a notch on a face end of an internal rotatable rod member of a tool adjacent a retaining nail of a brake shoe hold down hardware, the tool comprising the rotatable rod member 30 positioned longitudinally and internally to an external hollow tube member 12. Method 100 also comprises a step 120 of simultaneously applying axial pressure on the brake shoe hold down retainer cap so as to compress an associated hold down spring and manipulating a finger lever 34 on a terminating end of the internal rod member so as to align a flat barbed end of the retaining nail with a corresponding slot in the brake shoe hold down retaining cap In some versions, method 100 also has a step of removing the brake show hold down retainer nail while the notched face end of the rod is engaged to the retaining nail. In some versions of method 100, there is a step of manipulating the finger lever at least one of horizontally and longitudinally.

The finger lever preferably protrudes through a space in an external all of the external tube. Preferably, the finger lever 34 protrudes through the space in a direction perpendicular to a longitudinal axis of the tube member 12.

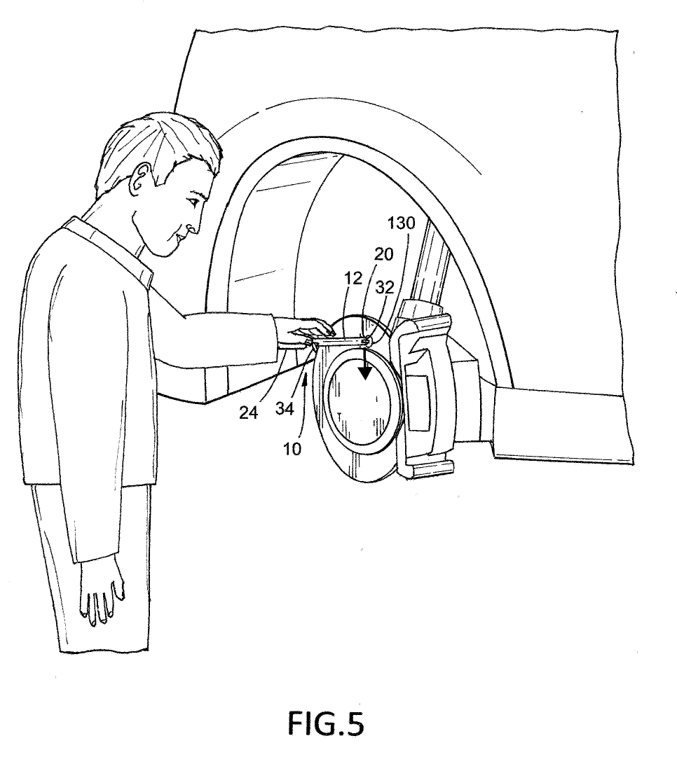

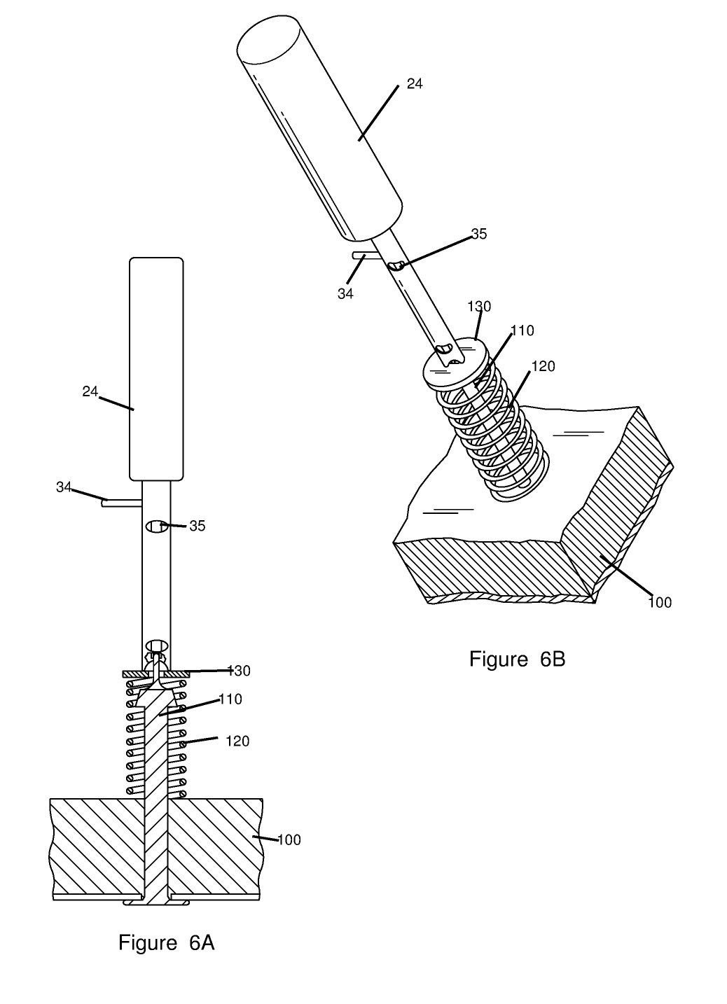

FIG. 6A shows a perspective view of the tool being used to remove a retaining cap in an embodiment of the present invention. FIG. 6B shows a side cutaway view of the tool being used to remove a retaining cap in an embodiment of the present invention. Here, the tool is shown with a handle 24 attached to a neck having portals 35. The finger lever 34 passes through a central hollow region of the elongated length of the tool and grasps an end of a retaining nail 110. At the same time, by pressing the tool in a direction towards the brake material 100 (down into the top of the retaining nail 110) the spring 120 is compressed. This compression then allows the finger lever 34 to rotate the cap 130 and remove the cap from the nail 110 due to the release of tension from the now compressed spring 120. The finger lever has a 90 degree bend, in embodiments, so that it extends out of a side portal 14 and bottom portal 20 of the shaft. The spring is compressed simultaneous to the rotation and removal of the cap 130. Refer to FIG. 4, the top view, showing the cap 130 with a slot 132. When the cap is rotated, or the slot 132 is rotated, the cap can be removed when the slot 132 aligns with the indentation 134.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A tool for removal and reinstallation of brake shoe hold down retaining hardware, the tool comprising;
an external hollow tube, the tube terminating in a grip end;
a rotatable solid rod member positioned longitudinally and internally with respect to the external hollow tube, wherein the internally positioned rod member is spaced apart from internal walls of the external hollow tube;
the internally positioned rod member having a face end, the face end having a notch, said notch configured to engage a protrusion of a nail of the brake shoe hold down hardware, the rod member also having at a rear end in a finger lever that is substantially perpendicular to a remainder of the rod member, said finger lever traversing the space on the surface of the tube, said finger lever configured to be turned longitudinally and horizontally.

2. The tool of claim 1, wherein the space is a plurality of washers.

3. The tool of claim 1, wherein the notch is configured to mate with a flat protrusion of the nail is flat.

4. The tool of claim 1, wherein the external hollow tube has a plurality of protrusions configured to maintain rotational position relative to the rotation of hold down nail.

5. The tool of claim 1, further comprising a gripper attached to the rear end of the tube.

6. The tool of claim 1, wherein the space in the tube is at a rear end of the tube.

7. The tool of claim 1, wherein the internally positioned rod member is spaced apart from internal walls of the external hollow.

8. A method of effectively disassembling and reassembling brake shoe hold down retainer hardware, the hardware including a retaining nail and a brake shoe hold down retaining cap, the method comprising:
positioning a notch on a face end of an internal rotatable rod member of a tool adjacent a retaining nail of a brake shoe hold down hardware, the tool comprising the rotatable rod member positioned longitudinally and internally to an external hollow tube member;
simultaneously applying axial pressure on the brake shoe hold down retainer cap so as to compress an associated hold down spring and manipulating a finger lever on a terminating end of the internal rod member so as to align a flat barbed end of the retaining nail with a corresponding slot in the brake shoe hold down retaining cap.

9. The method of claim 8, further comprising removing the brake show hold down retainer nail while the notched face end of the rod is engaged to the retaining nail.

10. The method of claim 8, wherein the manipulating comprises rotating the finger lever at least one of horizontally and longitudinally.

11. The method of claim 8, wherein the finger lever protrudes through a space in an external all of the external tube.

12. The method claim 8, wherein the finger lever protrudes in a direction perpendicular to a longitudinal axis of the tube member.

13. A tool for removal of a brake shoe comprising:
a solid handle;
a hollow elongated shaft connected to the handle;
at least one portal cut into a side of said hollow elongated shaft and extending at least 90 degrees of the outer circumference of the hollow elongated shaft;
a finger lever with 90 degree bend extending out of said at least one portal cut into a side of said hollow elongated shaft and a bottom portal of said hollow elongated shaft, said bottom portal being at a side of said hollow elongated shaft opposite said solid handle.

14. The tool of claim 13, further comprising an indentation in a side of said finger lever extending out of said bottom portal, said indentation adapted to grasp a slot of a brake cap.

15. A method of using the tool of claim 14, comprising the steps of:
placing said indentation against said brake cap;
pushing said solid handle and said hollow elongated shaft into said brake cap compressing a spring situated between said brake cap and said handle;
rotating said finger lever within said hollow elongated shaft causing said brake cap to rotate.
